(19) United States
(12) Patent Application Publication
(10) Pub. No.: US 2026/0009416 A1
(43) Pub. Date: Jan. 8, 2026

(54) FURNITURE ASSEMBLY

(71) Applicant: MAGICK WOODS EXPORTS PRIVATE LIMITED, MARAIMALAI NAGAR (IN)

(72) Inventor: Indrakumar Pathmanathan, Thronhill (CA)

(73) Assignee: MAGICK WOODS EXPORTS PRIVATE LIMITED, MARAIMALAI NAGAR (IN)

(21) Appl. No.: 18/976,206

(22) Filed: Dec. 10, 2024

(30) Foreign Application Priority Data
Jul. 4, 2024 (IN) 202441051382

(51) Int. Cl. F16B 12/14; F16B 5/02

(52) U.S. Cl. CPC F16B 12/14; F16B 5/0291

(57) ABSTRACT

A furniture assembly (100) and a method of assembling the furniture assembly (100) are disclosed. The furniture assembly (100) includes a first panel (102), a second panel (124), and a coupler element (136). The first panel (102) includes a first surface (108) having a cut-out surface (112) for accommodating the coupler element (136). The cut-out surface (112) includes a through hole (120). The second panel (124) includes a second surface (128) defining a first set of holes (132). The coupler element (136) includes a second set of holes (140) and a third hole (144). The coupler element (136) is coupled to the second panel (124) via fastening means extending from the second set of holes (140) to the first set of holes (132). The second panel (136) is secured to the first panel (102) via fastening means extending from the through hole (120) to the third hole (144).

### TECHNICAL FIELD

The present disclosure relates to the field of furniture. More specifically, the present disclosure relates to a furniture assembly having Do-It-Yourself (“DIY”) or user-friendly assembly components.

### BACKGROUND

Typically, there are various types of furniture and furniture assemblies are in existence. However, in the realm of customizable furniture assemblies, particularly for drawers and drawer front panels, there is a significant challenge in achieving both aesthetic uniformity and functional flexibility. For example, the furniture assemblies often lack ability to easily adjust position or height of the front panels relative to lateral walls of the drawer. This limitation hinders the customization options available to users, making it difficult to adapt furniture to varying design preferences and functional requirements. Accordingly, the only option left for a user is to alter the whole furniture assembly to achieve a desired position of the front panel with respect to the drawer.

Further, it is difficult for the users to easily and securely adjust positions of the front panels without compromising the structural integrity and appearance of the furniture. Existing solutions typically require complex and time-consuming modifications, which are not user-friendly and may result in inconsistent alignments. Therefore, there is a need for better tools and methods that simplify the furniture assembly for the users and help them to easily assemble the furniture.

### SUMMARY

According to an aspect of the present disclosure, a furniture assembly is described. The furniture assembly includes a first panel with a first width w1, a second panel with a second width w2, and at least one coupler element with a third width w3. The first panel includes a first surface having at least one cut-out surface. The at least one cut-out surface is defined by a depth d and includes at least one through hole. The third width w3 is equivalent to the depth d of the at least one cut-out surface. The second panel includes a second surface defining a first set of holes. The at least one coupler element includes a second set of holes and at least one third hole provided adjacent or in a proximity to the second set of holes. The at least one coupler element is coupled to the second panel via first fastening means extending from the second set of holes to the first set of holes, respectively. The at least one coupler element being accommodated in the at least one cut-out surface. The second panel is secured to the first panel via second fastening means extending from the at least one through hole to the at least one third hole.

In another aspect of the present disclosure, a coupler element for coupling a first panel with a second panel is described. The first panel defines a first width w1, a second panel defines a second width w2, and at least one coupler element defines a third width w3. The first panel includes a first surface having at least one cut-out surface. The at least one cut-out surface is defined by a depth d and includes at least one through hole. The third width w3 is equivalent to the depth d of the at least one cut-out surface. The second panel includes a second surface defining a first set of holes. The at least one coupler element includes a second set of holes and at least one third hole provided adjacent or in a proximity to the second set of holes. The at least one coupler element is coupled to the second panel via first fastening means extending from the second set of holes to the first set of holes, respectively. The at least one coupler element being accommodated in the at least one cut-out surface. The second panel is secured to the first panel via second fastening means extending from the at least one through hole to the at least one third hole.

In yet another aspect, a method of coupling a first panel with a second panel via a coupler element is described. The method includes coupling the coupler element to the second panel via the first fastening means extending from the second set of holes to the first set of holes, respectively. The method includes accommodating the coupler element in the at least one cut-out surface. The method includes securing the second panel to the first panel via the second fastening means extending from the at least one through hole to the at least one third hole.

### BRIEF DESCRIPTION OF THE DRAWINGS

FIG. 1 is an exemplary view of a furniture assembly, in accordance with which various embodiments of the present disclosure may be implemented;

FIG. 2 is an exemplary view of a coupler element and a second panel of the furniture assembly of FIG. 1, in accordance with an embodiment of the present disclosure;

FIG. 3 is enlarged and exploded view of a first panel, the second panel, and the coupler element of the furniture assembly of FIG. 1, in accordance with the embodiment of the present disclosure;

FIG. 4 illustrating exemplary inside and cross-sectional views of the furniture assembly of FIG. 1, in accordance with the embodiment of the present disclosure;

FIG. 5 is an exemplary view of the coupler element and the second panel of the furniture assembly of FIG. 1, in accordance with an embodiment of the present disclosure;

FIG. 6 is enlarged and exploded view of the first panel, the second panel, and the coupler element of the furniture assembly of FIG. 1, in accordance with the embodiment of the present disclosure;

FIG. 7 illustrating exemplary inside and cross-sectional views of the furniture assembly of FIG. 1, in accordance with the embodiment of the present disclosure;

FIG. 8 is an exemplary view of the second panel of the furniture assembly of FIG. 1, in accordance with an embodiment of the present disclosure;

FIG. 9 is enlarged and exploded view of the first panel, the second panel, and the coupler element of the furniture assembly of FIG. 1, in accordance with the embodiment of the present disclosure; and

FIG. 10 illustrating exemplary side and cross-sectional views of the furniture assembly of FIG. 1, in accordance with the embodiment of the present disclosure.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various embodiments of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts could refer to one or more comparable components used in the same and/or different depicted embodiments.

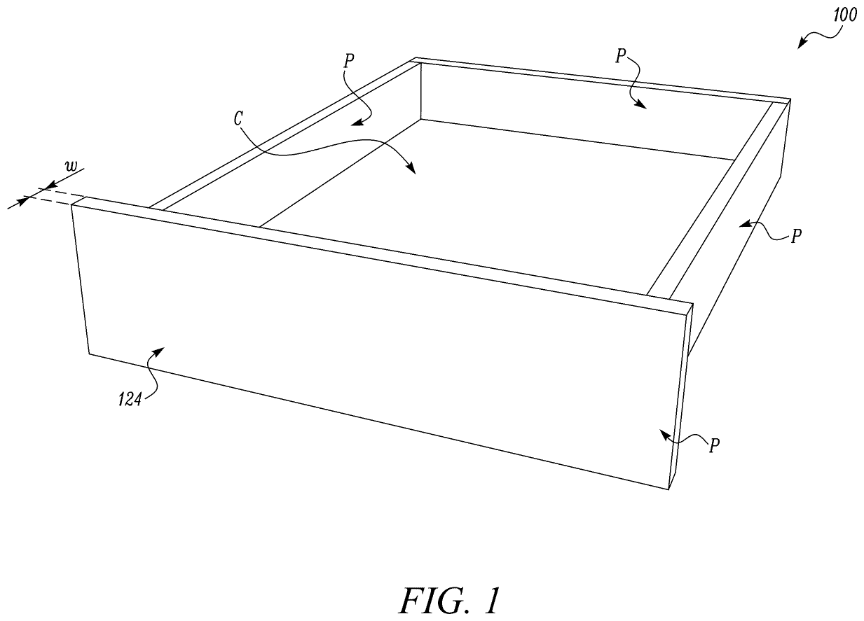

Referring to FIG. 1, an exemplary piece of furniture or furniture assembly 100 is shown and described. The furniture assembly 100 may refer to an object intended to support various human activities, such as holding, storing, seating, eating, working, sleeping, etc. Terms such as ‘furniture’ or ‘furniture assembly’, as used in the present disclosure, may include, but are not limited to, stools, chairs, sofas, tables, beds, hammocks, cupboards, shelves, drawers, cabinet, chest units, etc., that may be used by a user or a personnel for intended purposes.

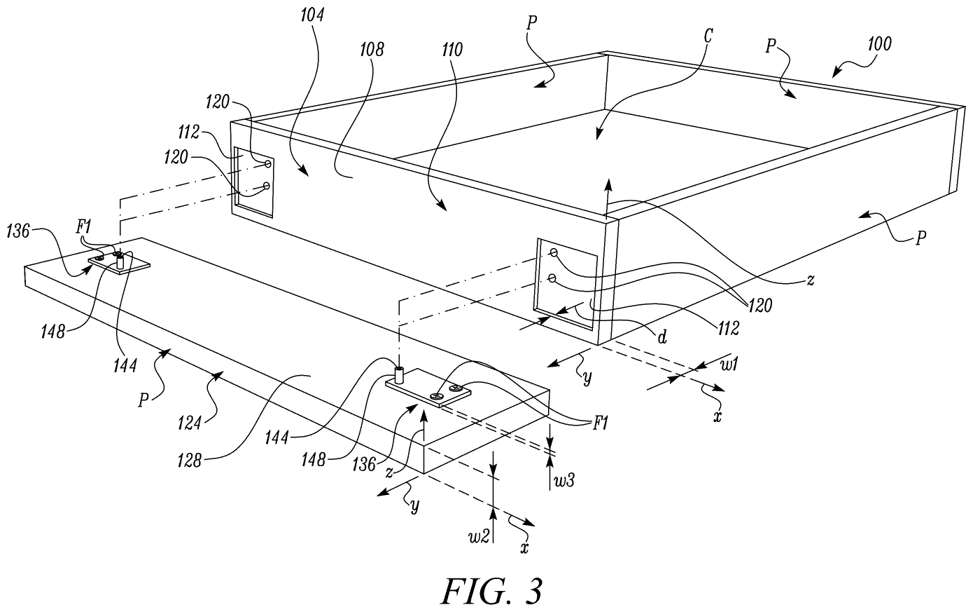

The furniture assembly 100 may include a plurality of panels P forming a desired type of furniture e.g., a drawer, as shown in FIG. 1. In some embodiments, each panel P may define a surface 110 (as shown in FIG. 3). The surface 110 may correspond to an area or a planar surface may be covered by each of the panels P. In some embodiments, the panel P may be made from materials including, but not limited to, metal, glass, plastic, and wood. In some embodiments, the furniture assembly 100 may be made using a variety of woodworking joints preferably fabricated of hardwood, such as cherry, oak, maple or walnut, utilizing cabinetry techniques well-known to a person of ordinary skill in the furniture field. For example, the panels P may undergo the woodworking joints to form the furniture assembly 100. The panels P may include various connections therebetween that may cooperate to form the furniture assembly 100. It is to be understood that the term “panels” is to be interpreted broadly as including not only self-contained units that are part of the furniture assembly 100, but the panels P may refer to a flat, often rectangular surface that are part of a larger piece of furniture assembly 100.

The furniture assembly 100 may correspond to a drawer that may define a cavity C. The cavity C may be formed by joining at least five panels P, as shown in FIG. 1. In some embodiments, the panels P of the furniture assembly 100 may include a first panel 104 that may correspond to a front portion of the furniture assembly 100 as shown in FIG. 3. The first panel 104 may include a first width w1 and a first surface 108. In some embodiments, the first width w1 may define a thickness of the first panel 104. In some embodiment, the first width w1 may define a distance between two opposite surfaces that may have larger surface area of the first panel 104. In some embodiments, the first panel 104 may include at least one cut-out surface 112 formed on the first surface 108. The cut-out surface 112 may be a surface provided partly inside the first surface 108 in a direction towards the first width w1 of the first panel 104. The cut-out surface 112 may include a depth d and at least one through hole 120. For example, the first panel 104 may include an inner surface 116 opposite to the first surface 108, and the through hole 120 that may extend from the inner surface 116 to the first surface 108.

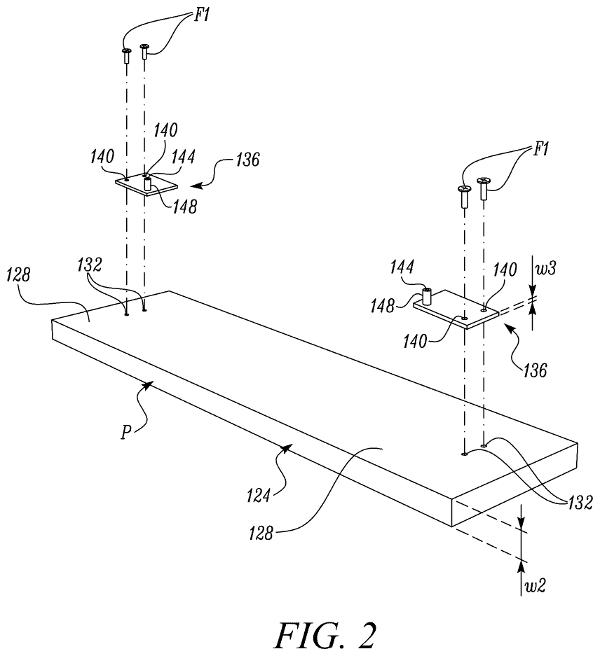

Referring to FIGS. 2 to6, the panels P of the furniture assembly 100 may include a second panel 124. In some embodiments, the second panel 124 may correspond to a drawer front of the drawer 100 as shown in FIG. 1. The drawer may be a slidable drawer that may be a part of a cabinet. In some embodiments, the cabinet may include a plurality of drawers 100 that may have the second panel 124 as a drawer front 124. In this regard, the drawer front 124 may be the panel P that provides an access to items may be placed inside the cavity C of the drawer. In some embodiments, the drawer front 104 may include a handle (not shown) allowing the user to pull the drawer 100 for the access. In some embodiments, the second panel 124 may be secured to the first panel 104 at one or more locations that may present on the first panel 104 described in later sections. In some embodiments, the second panel 124 may include a second width W2 and a second surface 128. In some embodiments, the second width W2 may define a thickness of the second panel 124. In some embodiment, the second width W2 may define a distance between two opposite surfaces that may have larger surface area of the second panel 124. In some embodiments, the second panel 124 may include one or more first set of holes 132 formed on the second surface 128. The first set of holes 132 may be formed partly inside the second surface 128. In some embodiments, the second panel 124 may include two first set of holes 132, as shown in FIG. 2.

The furniture assembly 100 may include a coupler element 136 for securing the first panel 104 with the second panel 124. In some embodiments, the coupler element 136 may include a third width w3. In some embodiments, the third width w3 may define a thickness of the coupler element 136. In some embodiment, the third width w3 may define a distance between two opposite surfaces that may have larger surface area of the coupler element 136. In some embodiments, the coupler element 136 may include one or more second set of holes 140 and at least one third hole 144 formed adjacent or in a proximity to the second set of holes 140, provided thereon. Terms such as ‘adjacent’ or ‘proximity’, and similar such terms, as used in the present disclosure, may correspond to a measurable distance between two holes (e.g., the third hole 144 and the second set of holes 140). In some embodiments, said terms may broadly refer to relative positioning of the two holes, where ‘adjacent’ indicates a minimal distance with the holes directly next to each other (e.g., 1 to 5 mm apart), while ‘proximity’ encompasses a broader range, covering near but not necessarily adjoining placements within a few millimeters to several centimeters on the coupler element 136. It should be noted that said terms may appear again in the disclosure below and may carry the same meaning as defined herein without any limitations. In some embodiments, the second set of holes 140 and the third hole 144 may correspond to through holes formed along the third width w3 of the coupler element 136. In some embodiments, the third width w3 may be equivalent to the depth d of the cut-out surface 112 of the first panel 104.

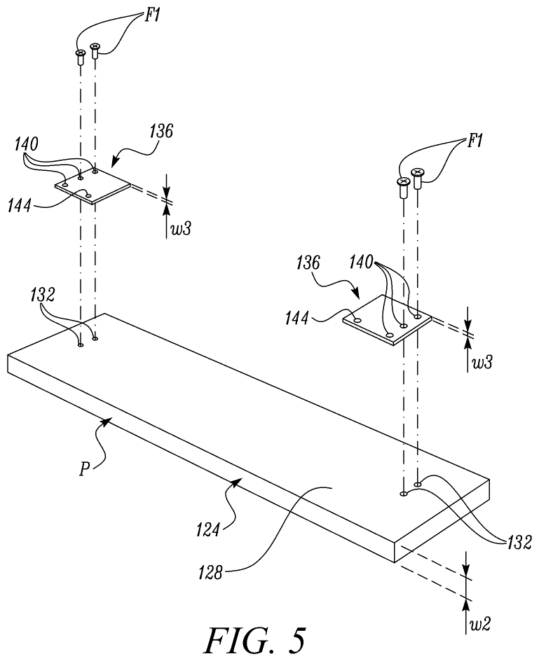

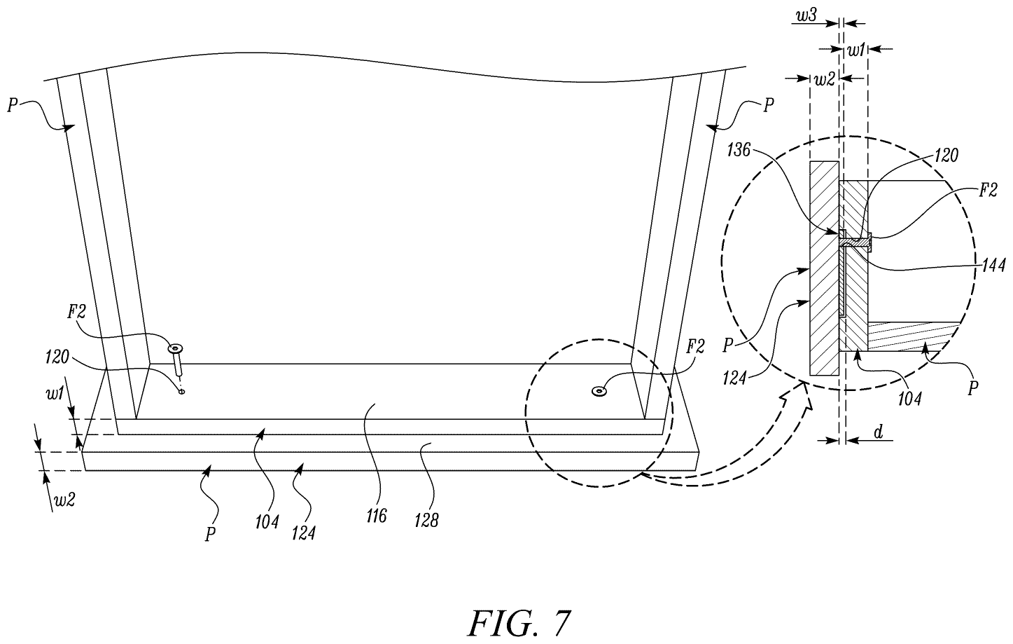

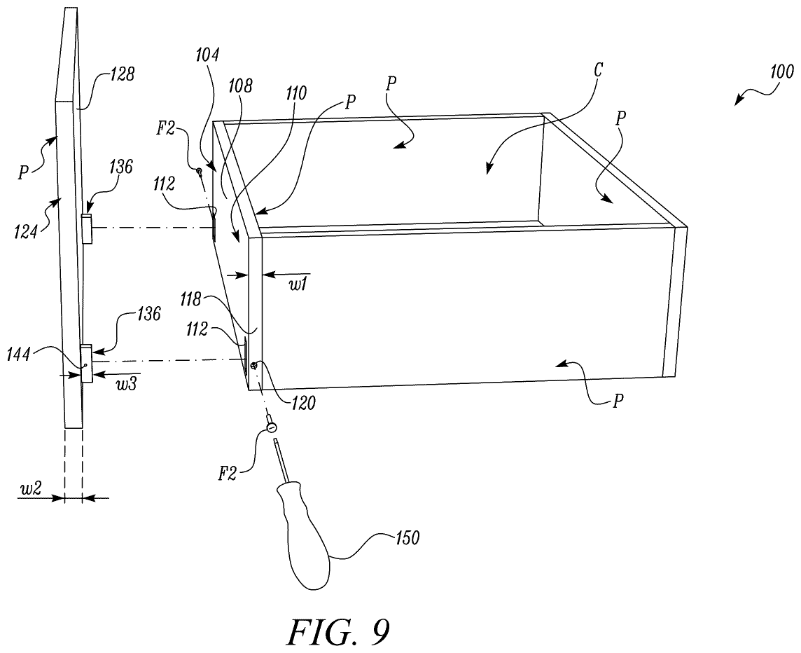

Referring to FIGS. 5 to 7, the coupler element 136 of the furniture assembly 100 may correspond to a coupler plate. The coupler plate be a metal plate made any suitable material, such as a steel etc. In some embodiments, the user may use a tool 150 as shown in FIG. 9 so that the coupler element 136 may be coupled to the second panel 124 via one or more first fastening means F1. For example, as shown in FIG. 5 to FIG. 7, the one or more first fastening means F1 may be extended from the corresponding second set of holes 140 of the coupler 136 to the corresponding first set of holes 132 of the second panel 124, thereby securing the coupler element 136 with the second panel 124. Upon securing the second panel 104 with the coupler element 136, the coupler element 136 may be accommodated in the cut-out surface 112 of the first panel 104. In some embodiments, the coupler element 136 may be secured with the first panel 104 via one or more second fastening means F2. For example, the one or more second fastening means F2 may be extended from the corresponding through holes 120 of the first panel 104 to the corresponding third hole 144 of the coupler element 136. Accordingly, the second fastening means F2 may facilitate securing the first panel 104 with the coupler element 136 thus with the second panel 124.

In some embodiments, the second fastening means F2 may include at least one elongated portion 148. The elongated portion 148 may be a cylindrical portion that may be removably attached to the at least one third hole 120 of the coupler element 136 as shown in FIGS. 2 and 3. In some embodiments, the elongated portion 148 may be immovably affixed to the third hole 120.

In some embodiments, the elongated portion 148 may include a cylindrical inner cavity not shown along a length of the elongated portion 148. For example, the cylindrical inner cavity may be aligned with the third hole 120 to receive the second fastening means F2. Accordingly, the second fastening means F2 may extend from the through hole 120 of the first panel 104 to the third hole 144. In some embodiments, the elongated portion 148 may include either internal threads, external threads, or both the internal threads and the external threads. In some embodiments, each of the through holes 120, the first set of holes 132, the second set of holes 140, and the third holes 144 may define internal threads where the corresponding first and second fastening means F1, F2 may be extended. In some embodiments, the first and second fastening means F1, F2 may include, but are not limited to, screws, bolts, nails, rivets, dowels, anchors, pins, etc. In some embodiments, the user may use the suitable tool 150 to drive the first and second fastening means F1, F2 that may include, but is not limited to, a screwdriver, a wrench, a hammer, a drill, a rachet, an impact driver, a nail gun, etc. It should be noted that for a person skill in the art, the above-mentioned fastening means F1, F2 and the tool 150 that may drive the fastening means F1, F2, may include other known suitable items without limiting the scope of the present invention.

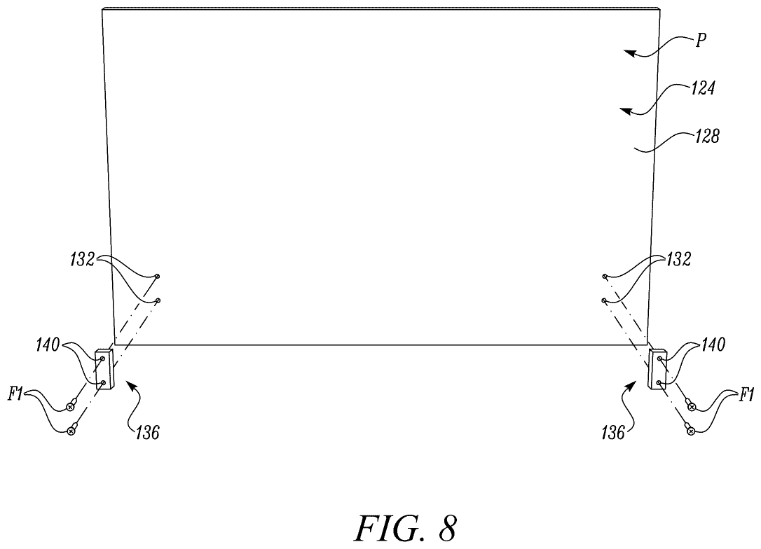

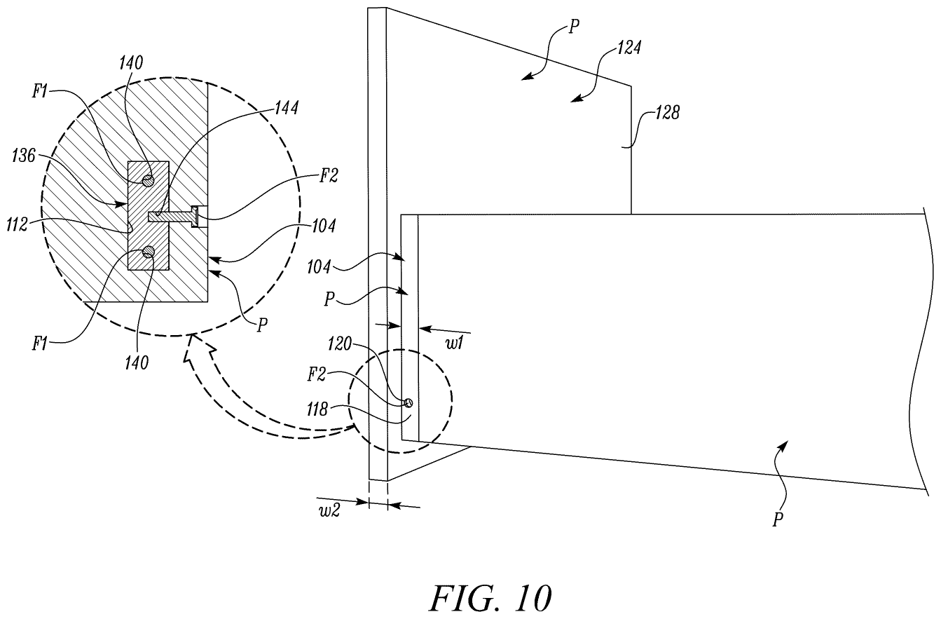

In some example implementations, the coupler element 136 of the furniture assembly 100 may correspond to a coupler block. Referring to FIGS. 8 to 10. The coupler block 136 may have a cuboidal structure that may define the third width w3 equivalent to the depth d of the cut-out surface 112 of the first panel 104. In some embodiments, the coupler block 136 may be fixedly attached to the second panel 124. For example, the user may use the tool 150 to attach the coupler block 136 fixedly with the second panel 124 via the first fastening means F1 extending from the second set of holes 140 to the first set of holes 132, respectively. In some embodiments, the coupler block 136 may be inserted in the corresponding cut-out surface 112 of the first panel 104. In such arrangement, the second panel 124 along with the coupler block 136 may be secured to the first panel 104. Accordingly, as shown in FIG. 9, the user may use the tool 150 to secure the first panel 104 with the second panel 124 via the second fastening means F2 extending from the corresponding through hole 120 to the corresponding third hole 144, respectively. In some embodiments, the third hole 144 may also be a through hole extending from a side surface of the coupler block 136 in a direction perpendicular to the width of the coupler block w3. In some embodiments, the first panel 104 may include a side surface 118 perpendicular to the first surface 108 and the inner surface 116. The side surface 118 may include at least one fourth hole 120, and the second panel 124 may be secured to the first panel 104 via the second fastening means F2 may be extending from the at least fourth hole 120 to the at least one third hole 144.

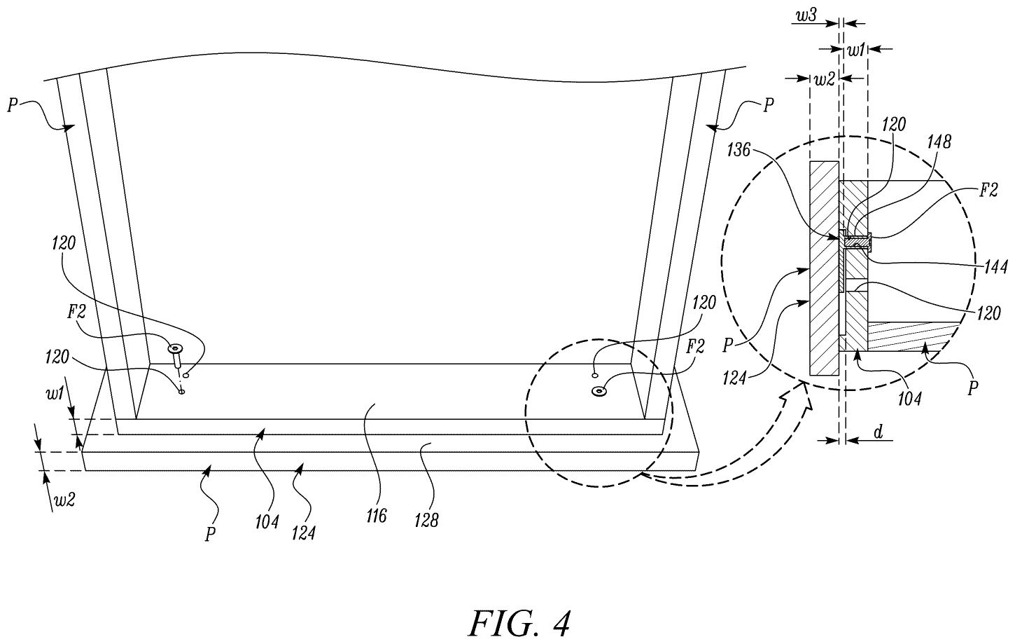

Referring to various embodiments of the present invention, as shown in FIGS. 1 to 10, a method of coupling the first panel 104 with the second panel 124 via the coupler element 136 is described. The method may include coupling the coupler element 136 to the second panel 124 may be via the first fastening means F1 extending from the second set of holes 140 to the first set of holes 132, respectively. The method may include accommodating the coupler element 136 in the at least one or the corresponding cut-out surface(s) 112 of the first panel 104. The method may include securing the second panel 124 to the first panel 104 may be via the second fastening means F2 extending from the at least one through hole 120 to the at least one third hole 144. In some embodiments, the method may further include securing the second panel 124 to the first panel 104 via the second fastening means F2 extending from at least fourth hole 120 as shown in FIG. 9 to the at least one third hole 144. In an embodiment, the method may include providing the fourth hole 120 on the side surface of the first panel 104.

It should be noted that the present invention provides the furniture assembly 100 that includes the first panel 104 and the second panel 124. In this regard, as discussed above, the second panel 124 may be secured to the first panel 104 via the second fastening means F2. The second fastening means F2 may be extended from the at least one through hole 120 to the at least one third hole 144. To this end, each of the through hole 120 and the third hole 144 may be substantially aligned with each other for a extending the second fastening means F2 therefrom. In some embodiments, each of the through hole 120 and the third hole 144 may be provided at various locations respectively on the first panel 104 and the coupler element 136. For example, the third hole 144 may be provided on the coupler element 136 adjacent or in a proximity to the second set of holes 140. The various locations of the through holes 120 and the third holes 144 may allow the user to adjust a position of the second panel 124 with respect to the first panel 104. For example, the user may adjust the position of the second panel 124 to adjust its height with respect to the ground on the first panel 104. Therefore, the present invention allows multiple customization options available to the user, making the furniture assembly 100 may be to adapt varying design preferences and functional requirements.

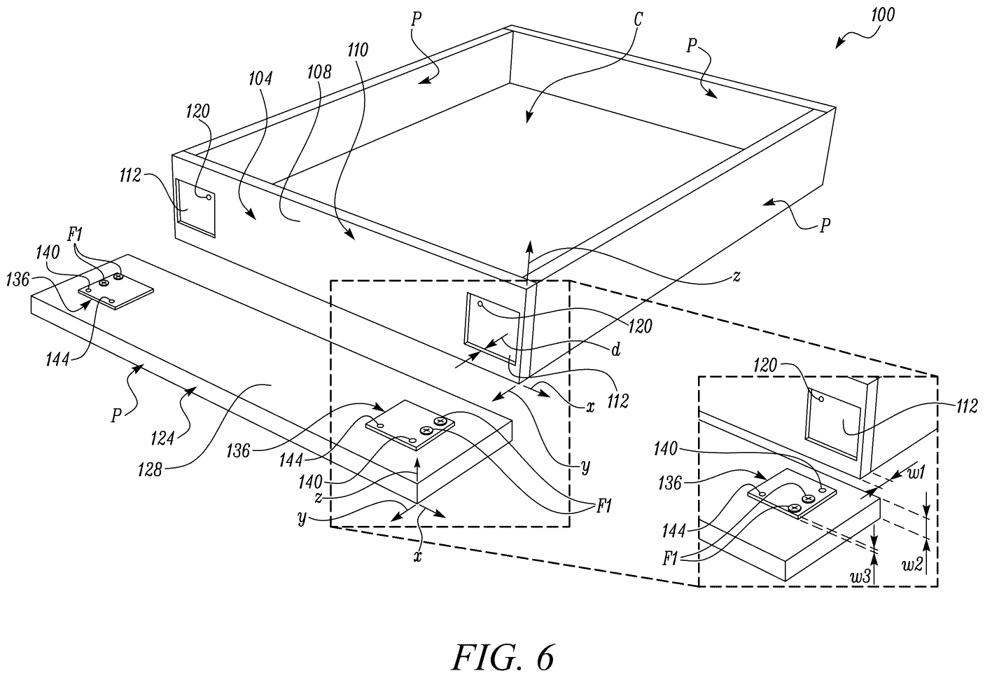

Referring to FIGS. 3 and 6, the position of the first panel 104 and the second panel 124 relative to axes XYZ, as well as positions of the cutout surface will be described.

### Panels P and Coupler Element 136:

In some embodiments, the first panel 104 may be located on an XZ plane and may extend in a positive X direction and a positive Z direction. The first width W1 of the first panel 104 may extend along the Y-axis. The first surface 108 of the first panel 104 may be oriented along an XZ plane. In some embodiments, the cutout surface 112 may be provided on the first panel 104 may be positioned along a Y-axis, and may be disposed near an edge of the first surface, at a predetermined distance therefrom. In some embodiments, two cut-out surfaces 112 may be provided away from each other along the XZ plane in a direction towards both ends of the first surface 108. The through holes 120 may be formed in the corresponding cutout surface 112, extending from the XZ plane in a direction inside the cut-out surface 112 along the Y-axis. In some embodiments, length of the through holes 120 may be less than the first width w1. In some embodiments, the second panel 124 may be located parallel to the first panel 104 on the XZ plane and may also extend in the positive X direction and the positive Z direction. The second width w2 of the second panel 124 extends along the Z-axis, as shown. The second surface 128 of the second panel 124 is oriented along the XY plane. In some embodiments, the third hole 144 and the elongated portion 148 may be located along the Z-axis and extend from the panel P in the positive Z-axis direction.

### Fastening Means F1 and F2

The coupler element 136 may be positioned to secure the first panel 104 with the second panel 124. In some embodiments, the first fastening means F1 and the second fastening means F2 may be used to secure the first panel 104 and the second panel 124 in place. To do so, both the first panel 104 and the second panel 124 may be arranged in the XZ plane with the coupler element 136 may be attached to the second panel 124. The second fastening means F2 may be extended from the corresponding through hole 120 inside the third hole 144.

### INDUSTRIAL APPLICABILITY

The furniture assembly 100 includes the first panel 104 with the first width w1 and the first surface 108 with the at least one cut-out surface 112. The cut-out surface 112 defined by the depth d and having the at least one through hole 120 or the fourth hole 120. Further, the furniture assembly 100 includes the second panel 124 with the second width w2 and having the second surface 128 with the first set of holes 132. The furniture assembly 100 further includes the at least one coupler element 136 with the third width w3 that is equivalent to the depth d of the cut-out surface 112. The coupler element 136 includes the second set of holes 144 and the third hole 144 adjacent or in a proximity to the second set of holes 144. The coupler element 136 attaches to the second panel 124 using the first fastening means F1 that connect through the corresponding sets of holes 140 and 132, and then, the coupler element 136 positions within the cut-out surface 112 on the first panel 104. Finally, to secure the second panel 124 with the first panel 104, the second fastening means F2 extend from the corresponding sets of holes 120 and 144. The present invention provides several advantages, some of which may include, but not limited to, a tool-less assembly: the design potentially allows for assembly and disassembly without the need for specialized tools, reducing the barriers for consumers who may not have such tools or skills to operate them. Time-saving construction: with a focus on easy-to-use coupling elements 136, the assembly 100 process may be significantly quicker than traditional methods, facilitating immediate use and convenience. Modularity and versatility: the assembly 100 allows the whole arrangement and rearrangement of furniture components or panels P to suit changing needs, i.e., living situations, personal preferences, or functional requirements of the user. Enhanced portability: owing to the ability to disassemble each panel P into first and second panels 104, 124 and the coupling elements 136, it becomes easier to transport furniture for relocations, sales, or donations, potentially reducing the environmental impact of discarded furniture. Robustness and stability: despite the simplicity of assembly 100, one implementation assures a stable and robust connection between furniture panels P that may not sacrifice the overall structural integrity of the assembled components. Reduced manufacturing complexity: the furniture assembly 100 may lead to streamlined manufacturing processes and potentially lower production costs. Sustainability: the furniture assembly 100 provides easier to disassemble, reuse, and reconfigurations, allowing extending the lifespan of each panel P. For instance, securing the second panel 124 onto the first panel 104 of the drawer 100 as shown in FIG. 1, may provide extending lifespan of each panel P used. Adaptability for customization: the present furniture assembly 100 may allow both manufacturers and consumers to customize the furniture according to individual desires or trends without needing significant modification to the core design. Reduced need for permanent joining methods: This one implementation minimizes or eliminates the need for gluing, welding, or other permanent joins that may make furniture difficult to recycle.

It should be noted that the present invention may incorporate various embodiments of one implementation and is not necessarily limited to a single manifestation of the described furniture assembly design.

In the preceding specification, the present disclosure and its advantages have been described with reference to specific embodiments. However, it will be apparent to a person of ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of present disclosure.

### LIST OF ELEMENTS

P—Panels
100—Furniture Assembly
104—First Panel
w1—First Width
108—First Surface
110—Surface
112—Cut-out surface
d—depth
116—Inner Surface
118—Side Surface
120—Through Holes, Fourth Hole
124—Second Panel
w2—Second Width
128—Second Surface
132—First Set of Holes
136—Coupler Element, Coupler Block
w3—Third Width
140—Second Set of Holes
144—Third Hole
148—Elongated Portion
150—Tool
F1—First Fastening Means
F2—Second Fastening Means

1. A furniture assembly comprising:
a first panel with a first width, the first panel including:
a first surface having at least one cut-out surface, wherein the at least one cut-out surface has a depth and includes at least one through hole; and
a second panel with a second width, the second panel including:
a second surface having a first set of holes; and
at least one coupler element with a third width equivalent to the depth of the at least one cut-out surface, the at least one coupler element including:
a second set of holes; and
at least one third hole provided in a proximity to the second set of holes, wherein the at least one coupler element is coupled to the second panel via first fastening means extending from the second set of holes to the first set of holes, respectively, and the at least one coupler element being accommodated in the at least one cut-out surface, and wherein the second panel is configured to be secured to the first panel via second fastening means extending from the at least one through hole to the at least one third hole.

2. The furniture assembly of claim 1, wherein:
the second fastening means comprises at least one elongated portion removably attached to the at least one third hole of the at least one coupler element, or the at least one elongated portion is affixed to the at least one third hole.

3. The furniture assembly of claim 2, wherein the at least one elongated portion defines a cylindrical inner cavity along a length of the at least one elongated portion.

4. The furniture assembly of claim 1, wherein the at least one third hole is a threaded through hole.

5. The furniture assembly of claim 2, wherein the elongated portion includes either internal threads, external threads, or both the internal threads and the external threads.

6. The furniture assembly of claim 1, wherein the at least one coupler element is either a coupler plate or a coupler block.

7. The furniture assembly of claim 6, wherein:
the coupler block is fixedly attached to the second panel via the first fastening means extending from the second set of holes to the first set of holes, respectively, and
the coupler block is inserted in the at least one cut-out surface and the second panel is secured to the first panel via the second fastening means extending from the at least one through hole to the at least one third hole, respectively.

8. The furniture assembly of claim 1, wherein:
the first panel comprises at least one fourth hole provided on a side surface perpendicular to the first surface of the first panel; and
the second panel is secured to the first panel via the second fastening means extending from the at least fourth hole to the at least one third hole.

9. The furniture assembly of claim 1, wherein the first fastening means and the second fastening means comprise screws, bolts, nails, rivets, dowels, anchors, pins, etc.

10. A coupler element for coupling a first panel with a second panel,
the first panel having a first width, the first panel including:
a first surface having at least one cut-out surface, wherein the at least one cut-out surface has a depth and includes at least one through hole; and
the second panel having a second width, the second panel including:
a second surface defining a first set of holes; and
the coupler element defining a third width W3 equivalent to the depth of the at least one cut-out surface,
the coupler element comprising:
a second set of holes; and
at least one third hole provided in a proximity to the second set of holes, wherein the at least one coupler element is coupled to the second panel via first fastening means extending from the second set of holes to the first set of holes, respectively, and the at least one coupler element being accommodated in the at least one cut-out surface, and wherein the second panel is secured to the first panel via second fastening means extending from the at least one through hole to the at least one third hole.

11. The coupler element of claim 10, wherein:
the second fastening means comprises at least one elongated portion removably attached to the at least one third hole of the coupler element, or the at least one elongated portion is immovably affixed to the at least one third hole.

12. The coupler element of claim 11, wherein the at least one elongated portion defines a cylindrical inner cavity along a length of the at least one elongated portion.

13. The coupler element of claim 10, wherein the at least one third hole is a threaded through hole.

14. The coupler element of claim 11, wherein the elongated portion includes either internal threads, external threads, or both the internal threads and the external threads.

15. The coupler element of claim 10, wherein the coupler element is a coupler plate or a coupler block.

16. The coupler element of claim 15, wherein:
the coupler block is fixedly attached to the second panel via the first fastening means extending from the second set of holes to the first set of holes, respectively, and
the coupler block is inserted in the at least one cut-out surface and the second panel is secured to the first panel via the second fastening means extending from the at least one through hole to the at least one third hole, respectively.

17. The coupler element of claim 10, wherein:
the first panel comprises at least one fourth hole provided on a side surface perpendicular to the first surface of the first panel; and
the second panel is secured to the first panel via the second fastening means extending from the at least fourth hole to the at least one third hole.

18. The coupler element of claim 10, wherein the first fastening means and the second fastening means comprise screws, bolts, nails, rivets, dowels, anchors, pins, etc.

19. A method of coupling a first panel with a second panel via a coupler element, wherein
the first panel with a first width, the first panel including:
a first surface having at least one cut-out surface, wherein the at least one cut-out surface has a depth and includes at least one through hole; and
the second panel with a second width, the second panel including:
a second surface having a first set of holes; and
at least one coupler element with a third width equivalent to the depth of the at least one cut-out surface, the at least one coupler element including:
a second set of holes; and
at least one third hole provided in a proximity to the second set of holes,
the method comprising:
coupling the coupler element to the second panel via a first fastening means extending from the second set of holes to the first set of holes, respectively;
accommodating the coupler element in the at least one cut-out surface; and
securing the second panel to the first panel via a second fastening means extending from the at least one through hole to the at least one third hole.

20. The method of claim 19, further comprising securing the second panel to the first panel via the second fastening means extending from at least fourth hole provided on a side surface to the at least one third hole.
